(19) United States
(12) Patent Application Publication
(10) Pub. No.: US 2026/0033553 A1
(43) Pub. Date: Feb. 5, 2026

(54) AN AEROSOL-GENERATING SYSTEM HAVING MEANS FOR DETERMINING WHETHER A SUSCEPTOR IS SUPPLIED WITH A LIQUID AEROSOL-FORMING SUBSTRATE

(71) Applicant: Philip Morris Products S.A., Neuchatel (CH)

(72) Inventors: Stéphane BILAT, Cortaillod (CH); Enrico STURA, Palézieux-Village (CH)

(73) Assignee: Philip Morris Products S.A., Neuchatel (CH)

(21) Appl. No.: 19/099,312

(22) PCT Filed: Aug. 10, 2023
(86) PCT No.: PCT/EP2023/072257

§ 371 Date: Jan. 28, 2025

(30) Foreign Application Priority Data
Aug. 11, 2022 (EP) 22189942.0

(51) Int. Cl. A24F 40/53; A24F 40/10; A24F 40/465; A24F 40/51; A24F 40/57; H05B 6/06; H05B 6/10

(52) U.S. Cl. CPC A24F 40/53; A24F 40/10; A24F 40/465; A24F 40/51; A24F 40/57; H05B 6/06; H05B 6/108

(57) ABSTRACT

An aerosol-generating system is provided, including: a liquid reservoir configured to store a liquid aerosol-forming substrate; a susceptor configured to receive a supply of liquid aerosol-forming substrate from the liquid reservoir and to heat the liquid aerosol-forming substrate to form an aerosol; an inductor coil configured to generate an alternating magnetic field for heating the susceptor; a power supply configured to supply electricity to the inductor coil; and control circuitry configured to determine a parameter indicative of a rate of temperature change of the susceptor, based on the electricity supplied to the inductor coil, and determine whether the susceptor is supplied with the liquid aerosol-forming substrate, based on a comparison between a dry susceptor threshold and the parameter indicative of the rate of temperature change of the susceptor. A method of controlling an aerosol-generating system is also provided.

The present disclosure relates to an aerosol-generating system. In particular, the present disclosure relates to an inductively heated aerosol-generating system for generating an aerosol from a liquid aerosol-forming substrate. The present disclosure also relates to an aerosol-generating device for use in the aerosol-generating system. The present disclosure further relates to a method of controlling an aerosol-generating system.

Aerosol-generating systems that employ inductive heating to heat an aerosol-forming substrate in order to generate an aerosol for user inhalation are generally known in the prior art. These systems typically comprise an aerosol-generating device including an inductive heating assembly, and a cartridge including an aerosol-forming substrate that, when heated, is capable of releasing volatile compounds that cool to form an inhalable aerosol. The cartridge is configured to be coupled to the aerosol-generating device. The inductive heating assembly comprises at least one inductor coil, which is configured to generate an alternating magnetic field. A susceptor, either forming part of the cartridge or the device, is arranged in close proximity to the aerosol-forming substrate and within the alternating magnetic field. When the susceptor is penetrated by the alternating magnetic field, the susceptor is heated by at least one of Joule heating from induced eddy currents in the susceptor and hysteresis losses. The heated susceptor heats the aerosol-forming substrate causing volatile compounds to be released from the aerosol-forming substrate, which cool to form an inhalable aerosol.

One advantage of inductive heating systems is that the electrical components of the system can be isolated from the aerosol-forming substrate and any generated aerosol. Another advantage is that the construction of the cartridge can be simplified because there is no need to provide electrical connection with the aerosol-generating device.

Some inductively heated aerosol-generating systems are configured for use with a liquid aerosol-forming substrate that is stored in a liquid reservoir. During use, as liquid aerosol-forming substrate is heated to generate an aerosol, the quantity of liquid aerosol-forming substrate in the liquid reservoir decreases. When the liquid reservoir is empty, or nearly empty, the quantity of liquid aerosol-forming substrate that is supplied to the susceptor may become insufficient to produce a satisfactory aerosol. For example, properties of the aerosol, such as the volume, composition or flavour, may become unsatisfactory. This may result in a poor user experience. A temporary interruption in the supply of liquid aerosol-forming substrate to the susceptor may also result in an unsatisfactory aerosol.

It would be desirable to provide an inductively heated aerosol-generating system that can determine whether the susceptor is supplied with liquid aerosol-forming substrate. It would be desirable that such an aerosol-generating system does not result in a substantial increase in the number of electrical components compared to some known prior art systems.

According to an example of the present disclosure, there is provided an aerosol-generating system. The aerosol-generating system comprises a liquid reservoir for storing a liquid aerosol-forming substrate. The aerosol-generating system comprises a susceptor for receiving a supply of liquid aerosol-forming substrate from the liquid reservoir and heating the liquid aerosol-forming substrate to form an aerosol. The aerosol-generating system comprises an inductor coil configured to generate an alternating magnetic field for heating the susceptor. The aerosol-generating system comprises a power supply configured to supply electricity to the inductor coil. The aerosol-generating system comprises control circuitry configured to determine a parameter indicative of a rate of temperature change of the susceptor, based on the electricity supplied to the inductor coil. The control circuitry is configured to determine whether the susceptor is supplied with the liquid aerosol-forming substrate, based on a comparison between a dry susceptor threshold and the parameter indicative of the rate of temperature change of the susceptor.

During heating and cooling of the susceptor, the rate of temperature change of the susceptor varies depending on whether or not the susceptor is supplied with liquid aerosol-forming substrate. This is because, when the susceptor is supplied with liquid aerosol-forming substrate, the susceptor dissipates a large proportion of heat by transferring the heat to the liquid aerosol-forming substrate. Whereas, when the susceptor is not supplied with liquid aerosol-forming substrate, the susceptor is not able to dissipate heat as quickly. During heating of the susceptor, and for the same power supply voltage, the rate of increase in temperature of the susceptor is lower when the susceptor is supplied with liquid aerosol-forming substrate compared to when the susceptor is not supplied with liquid aerosol-forming substrate. On the other hand, during cooling of the susceptor, the rate of decrease in temperature of the susceptor is greater when the susceptor is supplied with liquid aerosol-forming substrate compared to when the susceptor is not supplied with liquid aerosol-forming substrate. Advantageously, determining a parameter indicative of the rate of temperature change of the susceptor allows the control circuitry to determine whether the susceptor is supplied with liquid aerosol-forming substrate. This means that the control circuitry may perform an action in response to determining whether or not the susceptor is supplied with liquid aerosol-forming substrate.

The control circuitry determines whether the susceptor is supplied with the liquid aerosol-forming substrate based on a comparison between a dry susceptor threshold and the parameter indicative of the rate of temperature change of the susceptor. Advantageously, this allows the dry susceptor threshold to be selected to suit particular susceptor configurations or compositions of liquid aerosol-forming substrate.

The parameter indicative of a rate of temperature change of the susceptor is determined based on the electricity supplied to the inductor coil. Advantageously, this allows for remote detection of the rate of temperature change of the susceptor. That is, there is no need for a physical connection between the control circuitry and the susceptor. Another advantage is that there is no need to provide additional electrical components, such as a temperature sensor, in order to monitor the rate of temperature change of the susceptor.

As used herein, the term “based on the electricity” may refer to being “based on at least one of the current and voltage of the electricity”. Similarly, the term “based on the initial supply of electricity” may refer to being “based on at least one of the current and voltage of the initial supply of electricity”.

As used herein, the terms a “susceptor” or “susceptor element” means an element that is heatable by penetration with an alternating magnetic field. A susceptor is typically heatable by at least one of Joule heating through induction of eddy currents in the susceptor, and hysteresis losses. Possible materials for the susceptor include graphite, molybdenum, silicon carbide, stainless steels, niobium and aluminium. Advantageously, the susceptor may have a relative permeability between 1 and 40000. When a reliance on eddy currents for a majority of the heating is desirable, a lower permeability material may be used, and when hysteresis effects are desired then a higher permeability material may be used. Preferably, the material has a relative permeability between 500 and 40000.

The parameter indicative of the rate of temperature change of the susceptor may be based on an electrical property of the inductor coil. The parameter indicative of the rate of temperature change of the susceptor may be based on a quotient of the voltage and current of the electricity supplied to the inductor coil.

The parameter indicative of the rate of temperature change of the susceptor may be the rate of change of apparent ohmic resistance of the inductor coil. Alternatively, the parameter indicative of the rate of temperature change of the susceptor may be the rate of change of apparent conductance of the inductor coil. Advantageously, when the inductor coil and the susceptor are electromagnetically coupled, the rate of change of apparent resistance of the inductor coil is dependent on the rate of temperature change of the susceptor. Furthermore, there may be limited delay between a change in the temperature of the susceptor and the resulting change in the apparent resistance of the inductor coil. This means that the rate of change of apparent ohmic resistance may accurately indicate the rate of temperature change of the susceptor with limited time lag. As conductance is the mathematical inverse of resistance, the apparent conductance of the inductor coil is also dependent on the rate of temperature change of the susceptor.

As used herein, the term “apparent ohmic resistance” refers to the ohmic resistance that is “seen” by the inductor coil when the susceptor is electromagnetically coupled to the inductor coil. When the inductor coil and the susceptor are electromagnetically coupled, the apparent ohmic resistance of the inductor coil comprises both the ohmic resistance of the inductor coil and the ohmic resistance of the susceptor. In other words, when the inductor coil and the susceptor are electromagnetically coupled, the apparent ohmic resistance of the inductor coil is the equivalent ohmic resistance of the inductor coil and the susceptor. The ohmic resistance of the inductor coil remains relatively constant during inductive heating of the susceptor, whereas the ohmic resistance of the susceptor varies with temperature of the susceptor. Thus, the apparent ohmic resistance of the inductor coil varies with temperature of the susceptor. Conductance is the mathematical inverse of resistance, therefore the term “apparent conductance” can be similarly understood.

The parameter indicative of the rate of temperature change of the susceptor may be based on a first measurement of the electricity supplied to the inductor coil and a second measurement of the electricity supplied to the inductor coil.

The control circuitry may be configured to determine a first parameter indicative of a temperature of the susceptor based on the first measurement. For example, the first parameter indicative of the temperature of the susceptor may be a first apparent ohmic resistance of the inductor coil. The control circuitry may be configured to determine a second parameter indicative of a temperature of the susceptor based on the second measurement. For example, the second parameter indicative of the temperature of the susceptor may be a second apparent ohmic resistance of the inductor coil.

The control circuitry may be configured to determine a first parameter indicative of the rate of temperature change of the susceptor based on the first measurement. For example, the first parameter indicative of the rate of temperature change of the susceptor may be a first rate of change of apparent ohmic resistance of the inductor coil. The control circuitry may be configured to determine a second parameter indicative of the rate of temperature change of the susceptor based on the second measurement. For example, the second parameter indicative of the rate of temperature change of the susceptor may be a second rate of change of apparent ohmic resistance of the inductor coil. The parameter indicative of the rate of temperature change of the susceptor may be a mean average of the first parameter indicative of the rate of temperature change of the susceptor and the second parameter indicative of the rate of temperature change of the susceptor.

The first measurement and the second measurement may be separated by an interval of time. The interval of time may be less than 500 milliseconds, less than 400 milliseconds, less than 300 milliseconds, less than 250 milliseconds, less than 200 milliseconds, less than 150 milliseconds, less than 100 milliseconds, or less than 50 milliseconds. The interval of time may be between 50 milliseconds and 100 milliseconds. Preferably, the interval of time is between 50 milliseconds and 200 milliseconds. Advantageously, a short interval of time may allow the parameter indicative of the rate of temperature change of the susceptor to be determined a plurality of times during use of the aerosol-generating system.

The parameter indicative of the rate of temperature change of the susceptor may be a parameter indicative of the rate of increase of temperature of the susceptor.

The control circuitry may be configured to determine the parameter indicative of the rate of temperature change of the susceptor, based on the electricity supplied to the inductor coil during a heating period of the susceptor. During the heating period, the temperature of the susceptor increases from a first temperature to a second temperature. The temperature of the susceptor may not decrease during the heating period. The first temperature may be less than, or equal to, 100 Celsius. The second temperature may be greater than, or equal to, 100 Celsius. The first temperature may be between 50 Celsius and 100 Celsius, between 50 Celsius and 90 Celsius, between 50 Celsius and 80 Celsius, between 50 Celsius and 70 Celsius, or between 50 Celsius and 60 Celsius. The second temperature may be between 120 Celsius and 200 Celsius, between 130 Celsius and 200 Celsius, between 140 Celsius and 200 Celsius, or between 150 Celsius and 200 Celsius.

The parameter indicative of the rate of temperature change of the susceptor may be a parameter indicative of the rate of decrease of temperature of the susceptor.

The control circuitry may be configured to determine the parameter indicative of the rate of temperature change of the susceptor, based on the electricity supplied to the inductor coil during a cooling period of the susceptor. During the cooling period, the temperature of the susceptor decreases from a first temperature to a second temperature. The temperature of the susceptor may not increase during the cooling period. The first temperature may be greater than, or equal to, 100 Celsius. The second temperature may be less than, or equal to, 100 Celsius. The first temperature may be between 120 Celsius and 200 Celsius, between 130 Celsius and 200 Celsius, between 140 Celsius and 200 Celsius, or between 150 Celsius and 200 Celsius. The second temperature may be between 50 Celsius and 100 Celsius, between 50 Celsius and 90 Celsius, between 50 Celsius and 80 Celsius, between 50 Celsius and 70 Celsius, or between 50 Celsius and 60 Celsius.

The control circuitry may be configured to determine that the susceptor is supplied with liquid aerosol-forming substrate when the parameter indicative of the rate of temperature change of the susceptor is less than the dry susceptor threshold. In other words, the control circuitry may be configured to determine that the susceptor is not supplied with liquid aerosol-forming substrate when the parameter indicative of the rate of temperature change of the susceptor is greater than the dry susceptor threshold.

The dry susceptor threshold during cooling may be a different from the dry susceptor threshold during heating.

The control circuitry may be configured to determine whether the liquid reservoir is depleted based on whether the susceptor is supplied with liquid aerosol-forming substrate. Advantageously, this may allow the control circuitry to prevent further use of the aerosol-generating system until the liquid reservoir has been replenished.

The control circuitry may be configured to determine that the liquid reservoir is depleted when the susceptor is not supplied with liquid aerosol-forming substrate for a length of time equal to, or greater than, a time threshold. In other words, the control circuitry may be configured to determine that the liquid reservoir is depleted when the parameter indicative of the rate of temperature change of the susceptor is greater than the dry susceptor threshold for a length of time equal to, or greater than, a time threshold.

The control circuitry may be configured to determine that the liquid reservoir is depleted when the control circuitry determines that the susceptor is not supplied with liquid aerosol-forming substrate for greater than, or equal to, a predetermined number of consecutive times. Each determination that the susceptor is not supplied with liquid aerosol-forming substrate may be based on a separate measurement of the electricity supplied to the inductor coil. The predetermined number of times may be two, three, four, five, six, seven, eight, nine, or ten.

The control circuitry may be configured to detect an abnormal condition based on whether the susceptor is supplied with liquid aerosol-forming substrate. The control circuitry may be configured to detect an abnormal condition when the susceptor is not supplied with liquid aerosol-forming substrate for a length of time less than a time threshold. In other words, the control circuitry may be configured to detect an abnormal condition of the aerosol-generating system when the parameter indicative of the rate of temperature change of the susceptor is greater than the dry susceptor threshold for a length of time less than a time threshold.

The control circuitry may be configured to detect an abnormal condition when the control circuitry determines that the susceptor is not supplied with liquid aerosol-forming substrate for less than, or equal to, a predetermined number of consecutive times. Each determination that the susceptor is not supplied with liquid aerosol-forming substrate may be based on a separate measurement of the electricity supplied to the inductor coil. The predetermined number of times may be two, three, four, five, six, seven, eight, nine, or ten.

In an abnormal condition, the aerosol-generating system may not be functioning as designed. For example, the supply of liquid aerosol-forming substrate to the susceptor may be temporarily interrupted. This may be the result of how the aerosol-generating system is orientated.

The control circuitry may comprise an orientation sensor to detect the orientation of the liquid reservoir. The control circuitry may be configured to use the orientation sensor to determine whether the supply of liquid aerosol-forming substrate to the susceptor is temporarily disrupted.

The time threshold may be at least 10 milliseconds. The time threshold may be at least 50 milliseconds. The time threshold may be between 10 milliseconds and 2000 milliseconds, between 10 milliseconds and 1500 milliseconds, between 10 milliseconds and 1000 milliseconds, or between 50 milliseconds and 1000 milliseconds. The time threshold may be 10 milliseconds, 50 milliseconds, 100 milliseconds, 150 milliseconds, 200 milliseconds, 250 milliseconds, 300 millisecond, 350 millisecond, 400 milliseconds, 450 milliseconds, 500 milliseconds, 550 milliseconds, 600 milliseconds, 650 milliseconds, 700 milliseconds, 750 milliseconds, 800 milliseconds, 950 milliseconds, 1000 milliseconds, 1500 milliseconds or 2000 milliseconds.

The control circuitry may be configured to determine a fault condition when an abnormal condition is detected at least two times. The control circuitry may be configured to determine a fault condition when an abnormal condition is detected at least three times. The control circuitry may be configured to determine a fault condition when an abnormal condition is detected at least four times. The control circuitry may be configured to determine a fault condition when an abnormal condition is detected at least five times. In a fault condition, the control circuitry may determine that the abnormal condition is caused by a fault with the aerosol-generating system. For example, residue may be building up within the aerosol-generating system that is temporarily preventing the supply of liquid aerosol-forming substrate to the susceptor. In a fault condition, part of the system may need to be replaced in order to return the system to normal operation.

The control circuitry may be configured to provide an indication to the user when it is determined that the susceptor is not supplied with liquid aerosol-forming substrate. The control circuitry may be configured to provide an indication to the user when it is determined that the liquid reservoir is depleted. The control circuitry may be configured to provide an indication to the user when an abnormal condition is detected. The control circuitry may be configured to provide an indication to the user when a fault condition is detected.

The control circuitry may be configured to provide an aural indication to the user. For example, the aerosol-generating system may comprise a speaker. The control circuitry may be configured to operate the speaker to provide an aural indication to the user.

The control circuitry may be configured to provide a visual indication to the user. For example, the aerosol-generating system may comprise one or more indication lights. The control circuitry may be configured to operate the one or more indication lights to provide a visual indication to the user.

The control circuitry may be configured to provide a haptic indication to the user. For example, the aerosol-generating system may comprise a vibration motor. The control circuitry may be configured to operate the vibration motor to provide a haptic indication to the user.

The control circuitry may be configured to operate the aerosol-generating system in a first mode and a second mode. The first mode being different from the second mode.

The first mode may be a high power mode. In the high power mode, the control circuitry may be configured to supply the inductor coil with electricity. The second mode may be a low power mode. In the low power mode, the control circuitry may be configured to prevent the supply of electricity to the inductor coil. Alternatively, in the lower power mode, the control circuitry may be configured to supply the inductor coil with a lower voltage of electricity compared to the high power mode.

The control circuitry may be configured to operate the aerosol-generating system in the first mode when the susceptor is supplied with liquid aerosol-forming substrate. The control circuitry may be configured to operate the aerosol-generating system in the second mode when the susceptor is not supplied with liquid aerosol-forming substrate.

The control circuitry may be configured to operate the aerosol-generating system in the first mode when the liquid reservoir is not depleted. The control circuitry may be configured to operate the aerosol-generating system in the second mode when the liquid reservoir is depleted.

The control circuitry may be configured to operate the aerosol-generating system in the first mode when an abnormal condition is not detected. The control circuitry may be configured to operate the aerosol-generating system in the second mode when an abnormal condition is detected.

The control circuitry may be configured to operate the aerosol-generating system in the first mode when a fault condition is not detected. The control circuitry may be configured to operate the aerosol-generating system in the second mode when a fault condition is detected.

The aerosol-generating system may comprise an information storage component. The information storage component may be configured to store the dry susceptor threshold. The control circuitry may comprise means for retrieving the dry susceptor threshold from the information storage component. The information storage component may be an electronic memory. The electronic memory may be an RFID (radio frequency identification) tag. The information storage component may be a one-dimensional barcode. The information storage component may be a two-dimensional barcode.

The dry susceptor threshold may be predetermined. The dry susceptor threshold may be stored on the information storage component. The dry susceptor threshold may be stored in the information storage component during manufacture of the aerosol-generating system. The dry susceptor threshold may be determined experimentally. For example, the dry susceptor threshold may be determined by supplying the inductor coil with electricity when the susceptor is not supplied with liquid aerosol-forming substrate, and determining the parameter indicative of the rate of change of temperature of the susceptor which may then may be used as the dry susceptor threshold.

The control circuitry may be configured to determine the dry susceptor threshold. Advantageously, this may allow the aerosol-generating system to be used with liquid aerosol-forming substrate compositions and susceptor configurations for which the dry susceptor threshold has not been pre-programmed.

The control circuitry may be configured to determine the dry susceptor threshold based on an initial supply of electricity to the inductor coil. The initial supply of electricity may be supplied to the inductor coil when the aerosol-generating system is first turned on. The initial supply of electricity may be supplied to the inductor coil when a first puff is taken on the aerosol-generating system.

The control circuitry may be configured to determine a parameter indicative of an initial rate of temperature change of the susceptor, based on the initial supply of electricity to the inductor coil.

The susceptor may not be supplied with liquid aerosol-forming substrate during the initial supply of electricity to the inductor coil. For example, the aerosol-generating system may comprise a seal configured to prevent the susceptor from being supplied with liquid aerosol-forming substrate, and the seal may be broken after determination of the parameter indicative of the initial rate of temperature change of the susceptor. The dry susceptor threshold may be the parameter indicative of the initial rate of temperature change of the susceptor. In other words, the control circuitry stores the value of the parameter indicative of the initial rate of temperature change of the susceptor and uses the value as the dry susceptor threshold.

The aerosol-generating system may comprise a wicking element. The wicking element may be in fluid communication with the susceptor. The wicking element may be in fluid communication with the liquid reservoir. The wicking element may be arranged to convey liquid aerosol-forming substrate from the liquid reservoir to the susceptor. In particular, the wicking element may be arranged to convey liquid aerosol-forming substrate from the liquid reservoir across a major surface of the susceptor. The susceptor may be fixed to the wicking element. The susceptor may be integral with the wicking element.

The wicking element may comprise a capillary material. A capillary material is a material that is capable of transport of liquid from one end of the material to another by means of capillary action. The capillary material may have a fibrous or spongy structure. The capillary material preferably comprises a bundle of capillaries. For example, the capillary material may comprise a plurality of fibres or threads or other fine bore tubes. The fibres or threads may be generally aligned to convey liquid aerosol-forming substrate across a major surface of the susceptor. The capillary material may comprise sponge-like or foam-like material. The structure of the capillary material may form a plurality of small bores or tubes, through which the liquid aerosol-forming substrate can be transported by capillary action. Where the susceptor comprises interstices or apertures, the capillary material may extend into interstices or apertures in the susceptor element. The susceptor may draw liquid aerosol-forming substrate into the interstices or apertures by capillary action.

The susceptor may comprise one or more susceptor elements. The susceptor may be arranged substantially outside of the liquid reservoir. The or each susceptor element of the susceptor may be arranged substantially outside of the liquid reservoir. In particular, preferably, at least a portion of the major surfaces of the or each susceptor element is not in direct contact with the liquid reservoir. Preferably, at least a portion of two opposing major surfaces of the susceptor is in direct contact with air in an airflow passage in the system.

The susceptor may comprise a plurality of susceptor elements. The susceptor may comprise a first susceptor element, and a second susceptor element, the second susceptor element being spaced apart from the first susceptor element. A wicking element may be arranged in the space between the first susceptor element and the second susceptor element. The wicking element may comprise a first wicking layer and a second wicking layer. A spacer element may be positioned between the first wicking layer and the second wicking layer. The spacer element may be fluid permeable and may be configured to allow the liquid aerosol-forming substrate to move between the first wicking layer and the second wicking layer, through the spacer element.

The first susceptor element may be in physical contact with a first side of the first wicking element. A second side of the first wicking element may be in contact with a first side of the spacer element. A second side of the spacer element may be in contact with a first side of the second wicking element. A second side of the second wicking element may be in contact with the second susceptor element.

The first susceptor element, second susceptor element, and the wicking element may be substantially planar, and the first susceptor element may be arranged at a first side of the planar wicking element, and the second susceptor element may be arranged at a second side of the planar wicking element, opposite the first side.

The susceptor may be in the form of a mesh. The or each susceptor element may comprise a mesh. The susceptor, or susceptor element, may comprise an array of filaments forming a mesh. As used herein the term “mesh” encompasses grids and arrays of filaments having spaces therebetween. The term mesh also includes woven and non-woven fabrics.

The filaments may define interstices between the filaments and the interstices may have a width of between 10 micrometres and 100 micrometres. Preferably the filaments give rise to capillary action in the interstices, so that in use, the source liquid is drawn into the interstices, increasing the contact area between the susceptor element and the liquid.

The filaments may form a mesh of size between 160 and 600 Mesh US (+/−10%) (i.e. between 160 and 600 filaments per inch (+/−10%)). The width of the interstices may be between 35 micrometres and 140 micrometres, or between 25 micrometres and 75 micrometres. For example, the width of the interstices may be 40 micrometres, or 63 micrometres. The percentage of open area of the mesh, which is the ratio of the area of the interstices to the total area of the mesh is preferably between 25 and 56%. The mesh may be formed using different types of weave or lattice structures. Alternatively, the filaments consist of an array of filaments arranged parallel to one another.

The filaments may be formed by etching a sheet material, such as a foil. This may be particularly advantageous when the heater assembly comprises an array of parallel filaments. If the heating element comprises a mesh or fabric of filaments, the filaments may be individually formed and knitted together.

Preferably, the mesh is sintered. Advantageously, sintering the mesh creates electrical bonds between filaments extending in different directions. In particular, where the mesh comprises one or more of woven and non-woven fabrics, it is advantageous for the mesh to be sintered to create electrical bonds between overlapping filaments.

The mesh may also be characterised by its ability to retain liquid, as is well understood in the art.

The filaments of the mesh may have a diameter of between 8 micrometres and 100 micrometres, between 30 micrometres and 100 micrometres, between 8 micrometres and 50 micrometres, or between 8 micrometres and 39 micrometres. The filaments of the mesh may have a diameter of 50 micrometres.

The filaments of the mesh may have any suitable cross-section. For example, the filaments may have a round cross section or may have a flattened cross-section.

Advantageously, the mesh susceptor element may have a relative permeability between 1 and 40000. When a reliance on eddy currents for a majority of the heating is desirable, a lower permeability material may be used, and when hysteresis effects are desired then a higher permeability material may be used. Preferably, the material has a relative permeability between 500 and 40000. This may provide for efficient heating of the susceptor element.

The inductor coil may be a helical coil. The helical coil may be formed from a wire. The wire may have a circular cross-section. The wire may be made from copper. The helical coil may have a varying pitch. The inductor coil may have a circular cross section when viewed parallel to the longitudinal axis of the aerosol-generating device.

The inductor coil may comprise a first inductor coil and a second inductor coil. The first inductor coil may be configured to generate an alternating magnetic field for heating the susceptor. The control circuitry may be configured to determine a parameter indicative of a rate of temperature change of the susceptor, based on the electricity supplied to the second inductor coil.

The control circuitry may comprise a microprocessor. The microprocessor may be a programmable microprocessor, a microcontroller, or an application specific integrated chip (ASIC) or other electronic circuitry capable of providing control. The control circuitry may be configured to supply electricity to the inductor coil continuously following activation of the system or may be configured to supply electricity intermittently, such as on a puff-by-puff basis. The electricity may be supplied to the inductor coil in the form of pulses of electrical current, for example, by means of pulse width modulation (PWM). The control circuitry may comprise DC/AC inverter, which may comprise a Class-D or Class-E power amplifier. The control circuitry may comprise further electronic components. For example, in some embodiments, the control circuitry may comprise any of: sensors, switches, display elements.

The power supply may be a DC power supply. The power supply may be a battery. The battery may be a Lithium based battery, for example a Lithium-Cobalt, a Lithium-Iron-Phosphate, a Lithium Titanate or a Lithium-Polymer battery. The battery may be a Nickel-metal hydride battery or a Nickel cadmium battery. The power supply may be another form of charge storage device such as a capacitor. The power source may be rechargeable and be configured for many cycles of charge and discharge. The power source may have a capacity that allows for the storage of enough energy for one or more user experiences of the aerosol-generating system; for example, the power source may have sufficient capacity to allow for the continuous generation of aerosol for a period of around six minutes, corresponding to the typical time taken to smoke a conventional cigarette, or for a period that is a multiple of six minutes. In another example, the power source may have sufficient capacity to allow for a predetermined number of puffs or discrete activations of the atomiser assembly.

The aerosol-generating system may comprise an aerosol-generating device. The aerosol-generating device may comprise the power supply. The aerosol-generating device may comprise the inductor coil. The aerosol-generating device may comprise the control circuitry.

The aerosol-generating device may comprise a housing. The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material is preferably light and non-brittle.

The aerosol-generating device housing may define a cavity for receiving a cartridge. The aerosol-generating device may comprise one or more air inlets. The one or more air inlets may enable ambient air to be drawn into the cavity.

The aerosol-generating device may have a connection end configured to connect the aerosol-generating device to a cartridge. The connection end may comprise a cavity for receiving the cartridge.

The aerosol-generating device may have a distal end, opposite the connection end. The distal end may comprise an electrical connector configured to connect the aerosol-generating device to an electrical connector of an external power source, for charging the power source of the aerosol-generating device.

The aerosol-generating device may comprise a flux concentrator element. The flux concentrator element may have a greater radius than the inductor coil, and at least partially surround the inductor coil. The flux concentrator element may be configured to reduce the stray power losses from the generated magnetic field. The flux concentrator element may be configured to concentrate the alternating magnetic field, produced by the inductor coil, within the cavity.

The aerosol-generating system may comprise a cartridge. The cartridge may comprise the liquid reservoir. The cartridge may comprise the susceptor. The cartridge may comprise the information storage component.

The cartridge may comprise an outer housing. The outer housing may be formed from a durable material. The outer housing may be formed from a liquid impermeable material. The outer housing may be formed form a mouldable plastics material, such as polypropylene (PP) or polyethylene terephthalate (PET). The outer housing may be formed from the same material as the susceptor holder or may be formed from a different material.

The aerosol-generating system may comprise a liquid aerosol-forming substrate. The aerosol-forming substrate may be liquid at room temperature. The aerosol-forming substrate may comprise both liquid and solid components. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours.

The liquid aerosol-forming substrate may comprise nicotine and at least one aerosol-former. The aerosol-former may be glycerine or propylene glycol. The aerosol former may comprise both glycerine and propylene glycol. The liquid aerosol-forming substrate may have a nicotine concentration of between about 0.5% and about 10%, for example about 2%.

The cartridge may comprise two portions, a first portion and a second portion. The second portion may be movable relative to the first portion. The first and second portions of the cartridge may be movable relative to each other between a storage configuration and a use configuration. In the storage configuration, the susceptor may be isolated from the aerosol-forming substrate. In the use configuration, the susceptor may be in fluid communication with the aerosol-forming substrate.

The liquid reservoir may comprise two portions, a first portion and a second portion. A seal may be provided between the first portion and the second portion. The seal may be arranged to prevent fluid communication between the first portion of the liquid reservoir and the second portion of the liquid reservoir. In other words, the seal may fluidly isolate the first portion of the liquid reservoir from the second portion of the liquid reservoir. In the storage configuration, the liquid aerosol-forming substrate may be held in the first portion of the liquid reservoir. In the storage configuration, the seal may prevent the aerosol-forming substrate from flowing from the first portion of the liquid reservoir to the second portion of the liquid reservoir.

According to an example of the present disclosure, there is provided an aerosol-generating device. The aerosol-generating device may be an aerosol-generating device as disclosed herein. In particular, the aerosol-generating device may comprise the power supply, the inductor coil and the control circuitry disclosed herein.

According to an example of the present disclosure, there is provided a method of controlling an aerosol-generating system comprising a liquid reservoir for storing a liquid aerosol-forming substrate, a susceptor for receiving a supply of the liquid aerosol-forming substrate and an inductor coil configured to generate an alternating magnetic field for heating the susceptor. The method comprises supplying electricity to the inductor coil; determining a parameter indicative of a rate of temperature change of the susceptor based on the electricity supplied to the inductor coil; and determining whether the susceptor is supplied with the liquid aerosol-forming substrate, based on a comparison between a dry susceptor threshold and the parameter indicative of the rate of temperature change of the susceptor.

The method may further comprise operating the aerosol-generating system in a first mode when the susceptor is supplied with the liquid aerosol-forming substrate, and operating the aerosol-generating system in a second mode when the susceptor is not supplied with liquid aerosol-forming substrate.

It will be appreciated that any features described herein in relation to one example of the present disclosure may also be applicable to other examples of the present disclosure. In particular, features described in relation to the aerosol-generating system may also be applicable to the aerosol-generating device. Furthermore, features described in relation to the aerosol-generating system may also be applicable to the method of controlling an aerosol-generating system.

The invention is defined in the claims. However, below there is provided a non-exhaustive list of non-limiting examples. Any one or more of the features of these examples may be combined with any one or more features of another example, embodiment, or aspect described herein.
Ex1. An aerosol-generating system comprising:
   a liquid reservoir for storing a liquid aerosol-forming substrate;
   a susceptor for receiving a supply of liquid aerosol-forming substrate from the liquid reservoir and heating the liquid aerosol-forming substrate to form an aerosol;
   an inductor coil configured to generate an alternating magnetic field for heating the susceptor;
   a power supply configured to supply electricity to the inductor coil;
   control circuitry configured to determine a parameter indicative of a rate of temperature change of the susceptor, based on the electricity supplied to the inductor coil; and
   wherein the control circuitry is configured to determine whether the susceptor is supplied with the liquid aerosol-forming substrate, based on a comparison between a dry susceptor threshold and the parameter indicative of the rate of temperature change of the susceptor.
Ex2. An aerosol-generating system according to Ex1, wherein the parameter indicative of the rate of temperature change of the susceptor is based on an electrical property of the inductor coil.
Ex3. An aerosol-generating system according to Ex1 or Ex2, wherein the parameter indicative of the rate of temperature change of the susceptor is based on a quotient of the voltage and current of the electricity supplied to the inductor coil.
Ex4. An aerosol-generating system according to any preceding example, wherein the parameter indicative of the rate of temperature change of the susceptor is the rate of change of apparent ohmic resistance of the inductor coil.
Ex5. An aerosol-generating system according to any one of Ex1 to Ex3, wherein the parameter indicative of the rate of temperature change of the susceptor is the rate of change of apparent conductance of the inductor coil.
Ex6. An aerosol-generating system according to any preceding example, wherein the parameter indicative of the rate of temperature change of the susceptor is based on a first measurement of the electricity supplied to the inductor coil and a second measurement of the electricity supplied to the inductor coil.
Ex7. An aerosol-generating system according to Ex6, wherein the control circuitry is configured to determine a first parameter indicative of a temperature of the susceptor based on the first measurement.
Ex8. An aerosol-generating system according to Ex6 or Ex7, wherein the control circuitry is configured to determine a second parameter indicative of a temperature of the susceptor based on the second measurement.
Ex9. An aerosol-generating system according to Ex6, wherein the control circuitry is configured to determine a first parameter indicative of the rate of temperature change of the susceptor based on the first measurement.
Ex10. An aerosol-generating system according to Ex6 or Ex9, wherein the control circuitry is configured to determine a second parameter indicative of the rate of temperature change of the susceptor based on the second measurement.
Ex11. An aerosol-generating system according to Ex9 or Ex10, wherein the parameter indicative of the rate of temperature change of the susceptor is a mean average of the first parameter indicative of the rate of temperature change of the susceptor and the second parameter indicative of the rate of temperature change of the susceptor.
Ex12. An aerosol-generating system according to any one of Ex6 to Ex11, wherein the first measurement and the second measurement are separated by an interval of time.
Ex13. An aerosol-generating system according to Ex12, wherein the interval of time is less than 500 milliseconds, less than 400 milliseconds, less than 300 milliseconds, less than 250 milliseconds, less than 200 milliseconds, less than 150 milliseconds, less than 100 milliseconds, or less than 50 milliseconds.
Ex14. An aerosol-generating system according to any preceding example, wherein the control circuitry is configured to determine the parameter indicative of the rate of temperature change of the susceptor, based on the electricity supplied to the inductor coil during a heating period of the susceptor.
Ex15. An aerosol-generating system according to any preceding example, wherein the control circuitry is configured to determine the parameter indicative of the rate of temperature change of the susceptor, based on the electricity supplied to the inductor coil during a cooling period of the susceptor.
Ex16. An aerosol-generating system according to any preceding example, wherein the control circuitry is configured to determine that the susceptor is supplied with liquid aerosol-forming substrate when the parameter indicative of the rate of temperature change of the susceptor is less than the dry susceptor threshold.
Ex17. An aerosol-generating system according to any preceding example, wherein the control circuitry is configured to determine that the susceptor is not supplied with liquid aerosol-forming substrate when the parameter indicative of the rate of temperature change of the susceptor is greater than the dry susceptor threshold.
Ex18. An aerosol-generating system according to any preceding example, wherein the control circuitry is configured to determine whether the liquid reservoir is depleted based on whether the susceptor is supplied with liquid aerosol-forming substrate.
Ex19. An aerosol-generating system according to any preceding example, wherein the control circuitry is configured to determine that the liquid reservoir is depleted when the susceptor is not supplied with liquid aerosol-forming substrate for a length of time equal to, or greater than, a time threshold.
Ex20. An aerosol-generating system according to any preceding example, wherein the control circuitry is configured to detect an abnormal condition based on whether the susceptor is supplied with liquid aerosol-forming substrate.
Ex21. An aerosol-generating system according to any preceding example, wherein the control circuitry is configured to detect an abnormal condition when the susceptor is not supplied with liquid aerosol-forming substrate for a length of time less than a time threshold.
Ex22. An aerosol-generating system according to Ex19 or Ex21, wherein the time threshold is between 50 milliseconds and 1000 milliseconds.
Ex23. An aerosol-generating system according to any one of Ex20 to Ex22, wherein the control circuitry is configured to determine a fault condition when an abnormal condition is detected at least two times.
Ex24. An aerosol-generating system according to any preceding example, wherein the control circuitry is configured to provide an indication to the user when it is determined that the susceptor is not supplied with liquid aerosol-forming substrate.
Ex25. An aerosol-generating system according to any preceding example, wherein the control circuitry is configured to provide an indication to the user when it is determined that the liquid reservoir is depleted.
Ex26. An aerosol-generating system according to any preceding example, wherein the control circuitry is configured to provide an indication to the user when an abnormal condition is detected.
Ex27. An aerosol-generating system according to any preceding example, wherein the control circuitry is configured to provide an indication to the user when a fault condition is detected.
Ex28. An aerosol-generating system according to any one of Ex24 to Ex27, wherein the control circuitry is configured to provide an aural indication to the user.
Ex29. An aerosol-generating system according to any one of Ex24 to Ex27, wherein the control circuitry is configured to provide a visual indication to the user.
Ex30. An aerosol-generating system according to any one of Ex24 to Ex27, wherein the control circuitry is configured to provide a haptic indication to the user.
Ex31. An aerosol-generating system according to any preceding example, wherein the control circuitry is configured to operate the aerosol-generating system in a first mode and a second mode, the first mode being different from the second mode.
Ex32. An aerosol-generating system according to Ex31, wherein the first mode is a high power mode in which the control circuitry may be configured to supply the inductor coil with electricity.
Ex33. An aerosol-generating system according to Ex31 or Ex32, wherein the second mode is a low power mode.
Ex34. An aerosol-generating system according to Ex33, wherein, in the lower power mode, the control circuitry may be configured to prevent the supply of electricity to the inductor coil.
Ex35. An aerosol-generating system according to Ex33, wherein, in the lower power mode, the control circuitry is configured to supply the inductor coil with a lower voltage of electricity compared to the high power mode.
Ex36. An aerosol-generating system according to Ex31 to Ex35, wherein the control circuitry is configured to operate the aerosol-generating system in the first mode when the susceptor is supplied with liquid aerosol-forming substrate.
Ex37. An aerosol-generating system according to Ex31 to Ex36, wherein the control circuitry is configured to operate the aerosol-generating system in the second mode when the susceptor is not supplied with liquid aerosol-forming substrate.
Ex38. An aerosol-generating system according to any preceding example comprising an information storage component configured to store the dry susceptor threshold.
Ex39. An aerosol-generating system according to Ex38, wherein the information storage component is an electronic memory.
Ex40. An aerosol-generating system according to Ex38, wherein the information storage component is an RFID (radio frequency identification) tag.
Ex41. An aerosol-generating system according to Ex38, wherein the information storage component is a one-dimensional barcode.
Ex42. An aerosol-generating system according to Ex28, wherein the information storage component is a two-component barcode.
Ex43. An aerosol-generating system according Ex38 to E42, wherein the dry susceptor threshold is predetermined and stored on the information storage component.
Ex44. An aerosol-generating system according to any one of Ex1 to Ex42, wherein the control circuitry is configured to determine the dry susceptor threshold.
Ex45. An aerosol-generating system according to Ex44, wherein the control circuitry may be configured to determine the dry susceptor threshold based on an initial supply of electricity to the inductor coil.
Ex46. An aerosol-generating system according to Ex45, wherein the initial supply of electricity is supplied to the inductor coil when the aerosol-generating system is first turned on.
Ex47. An aerosol-generating system according to Ex45, wherein the initial supply of electricity is supplied to the inductor coil when a first puff is taken on the aerosol-generating system.
Ex48. An aerosol-generating system according to any one of Ex45 to Ex47, wherein the control circuitry is configured to determine a parameter indicative of an initial rate of temperature change of the susceptor, based on the initial supply of electricity to the inductor coil.
Ex49. An aerosol-generating system according to any one of Ex45 to Ex48, wherein the susceptor is not supplied with liquid aerosol-forming substrate during the initial supply of electricity to the inductor coil.
Ex50. An aerosol-generating system according to Ex49, wherein the dry susceptor threshold is the parameter indicative of an initial rate of temperature change of the susceptor.
Ex51. An aerosol-generating system according to any preceding example comprising a wicking element arranged to convey liquid aerosol-forming substrate from the liquid reservoir to the susceptor.
Ex52. An aerosol-generating system according to any preceding example, wherein the susceptor is arranged substantially outside of the liquid reservoir.
Ex53. An aerosol-generating system according to any preceding example, wherein the susceptor comprises a first susceptor element, and a second susceptor element, the second susceptor element being spaced apart from the first susceptor element.
Ex54. An aerosol-generating system according to Ex53, wherein a, or the, wicking element is arranged in the space between the first susceptor element and the second susceptor element.
Ex55. An aerosol-generating system according to any preceding example, wherein the susceptor comprises a mesh.
Ex56. An aerosol-generating system according to any preceding example, wherein the inductor coil is a helical coil.
Ex57. An aerosol-generating system according to Ex56, wherein the helical coil is formed from a wire.
Ex58. An aerosol-generating system according to Ex57, wherein the wire has a circular cross-section.
Ex59. An aerosol-generating system according to Ex57 or Ex58, wherein the wire is made from copper.
Ex60. An aerosol-generating system according to any preceding example, wherein the inductor coil comprises a first inductor coil and a second inductor coil, wherein the first inductor coil is configured to generate an alternating magnetic field for heating the susceptor and the control circuitry is configured to determine a parameter indicative of a rate of temperature change of the susceptor, based on the electricity supplied to the second inductor coil.
Ex61. An aerosol-generating system according to any preceding example, wherein the power supply is a DC power supply.
Ex62. An aerosol-generating system according to any preceding example comprising an aerosol-generating device comprising the power supply, the inductor coil, and the control circuitry.
Ex63. An aerosol-generating system according to any preceding example comprising a cartridge comprising the liquid reservoir and the susceptor.
Ex64. An aerosol-generating system according to Ex63, wherein the cartridge comprises the information storage component.
Ex65. An aerosol-generating device for use in the aerosol-generating system according to any preceding example, comprising the power supply, the inductor coil, and the control circuitry.
Ex66. A method of controlling an aerosol-generating system comprising a liquid reservoir for storing a liquid aerosol-forming substrate, a susceptor for receiving a supply of the liquid aerosol-forming substrate and an inductor coil, the method comprising:
   supplying electricity to the inductor coil;
   determining a parameter indicative of a rate of temperature change of the susceptor based on the electricity supplied to the inductor coil; and
   determining whether the susceptor is supplied with the liquid aerosol-forming substrate, based on a comparison between a dry susceptor threshold and the parameter indicative of the rate of temperature change of the susceptor.
Ex67. A method according to Ex66, further comprising operating the aerosol-generating system in a first mode when the susceptor is supplied with the liquid aerosol-forming substrate, and operating the aerosol-generating system in a second mode when the susceptor is not supplied with liquid aerosol-forming substrate.

Examples will now be further described with reference to the figures in which:

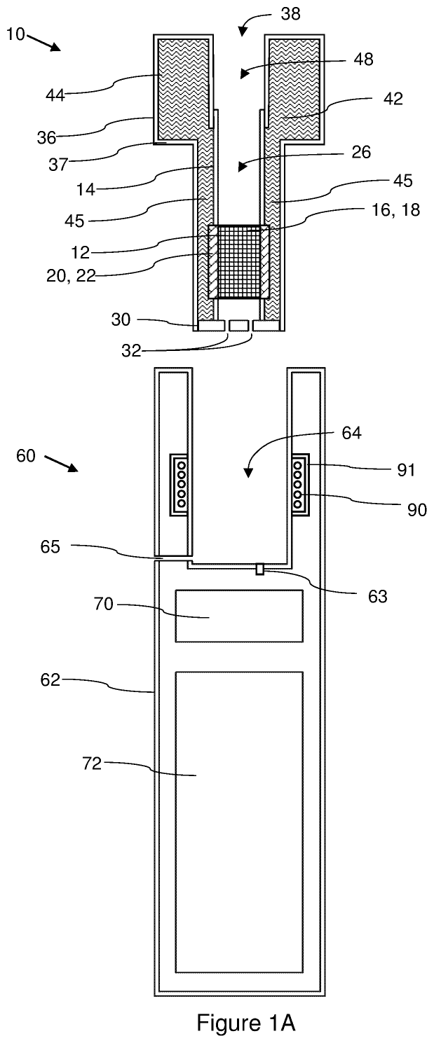

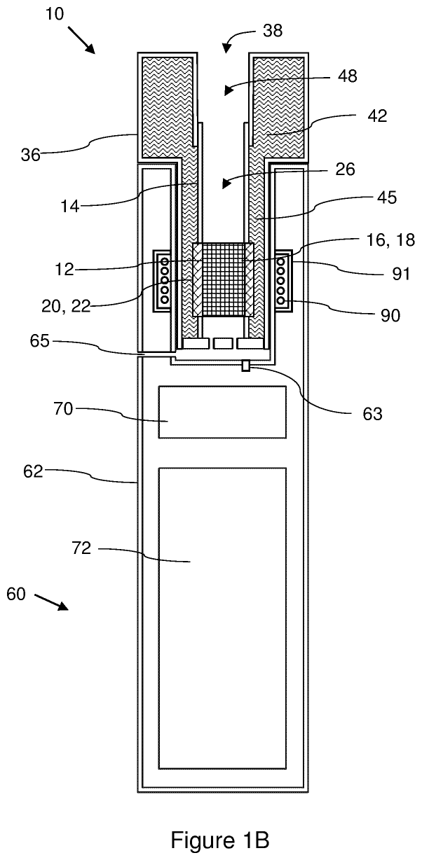

FIG. 1A shows a schematic illustration of a cross section of an aerosol-generating system according to an example of the present disclosure;

FIG. 1B shows a schematic illustration of a cross section of the aerosol-generating system of FIG. 1A, wherein the system is in use configuration;

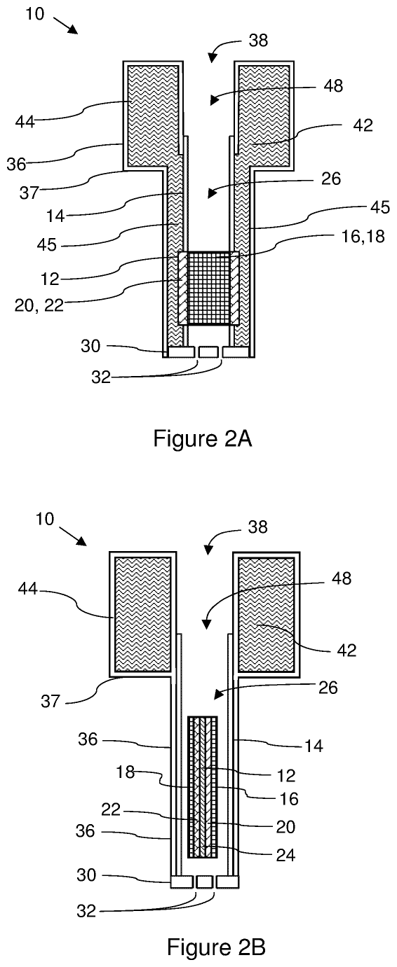

FIG. 2A shows a schematic illustration of a cross section of the cartridge of FIGS. 1A and 1B;

FIG. 2B shows a schematic illustration of a cross section of the cartridge of FIG. 2A rotated by 90 degrees about a central longitudinal axis of the cartridge;

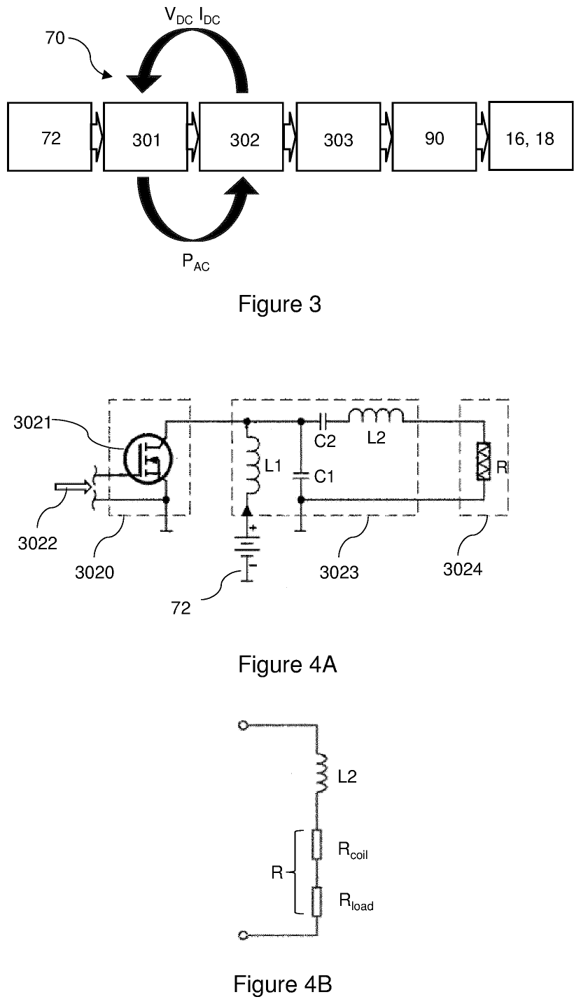

FIG. 3 shows a block diagram of electronic components of the aerosol-generating system;

FIGS. 4A and 4B show some components of the control circuitry;

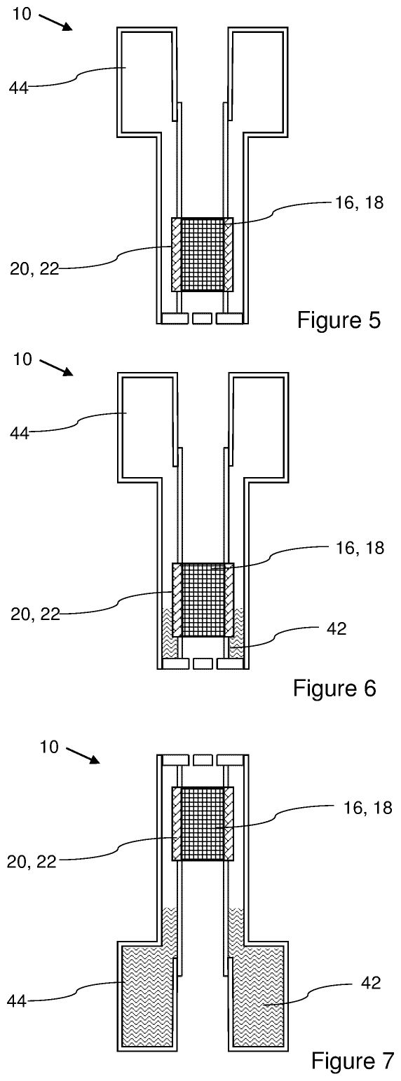

FIGS. 5, 6 and 7 show scenarios in which the supply of liquid aerosol-forming substrate from the liquid reservoir to susceptor may become interrupted;

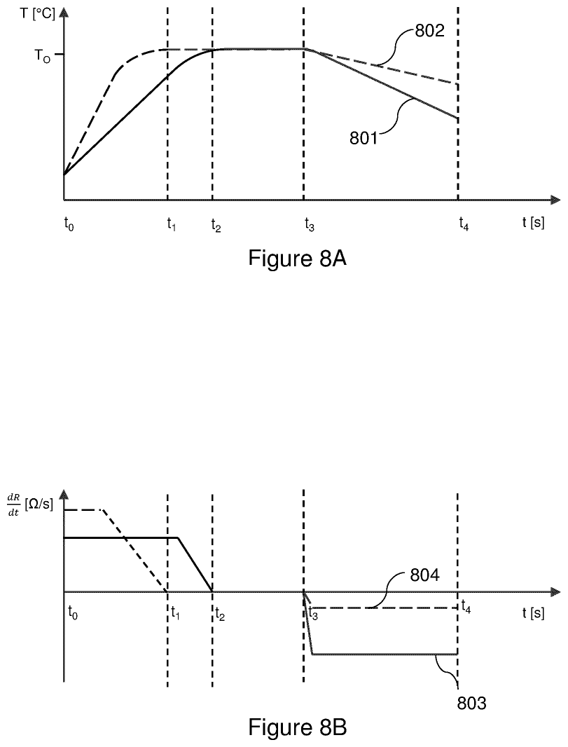

FIG. 8A shows a graph illustrating an example of temperature variations of a susceptor when the susceptor is supplied with liquid aerosol-forming substrate and when the susceptor is not supplied with liquid aerosol-forming substrate;

FIG. 8B shows a graph illustrating the rate of change of apparent ohmic resistance of the inductor coil associated with the temperature variations illustrated in FIG. 8A;

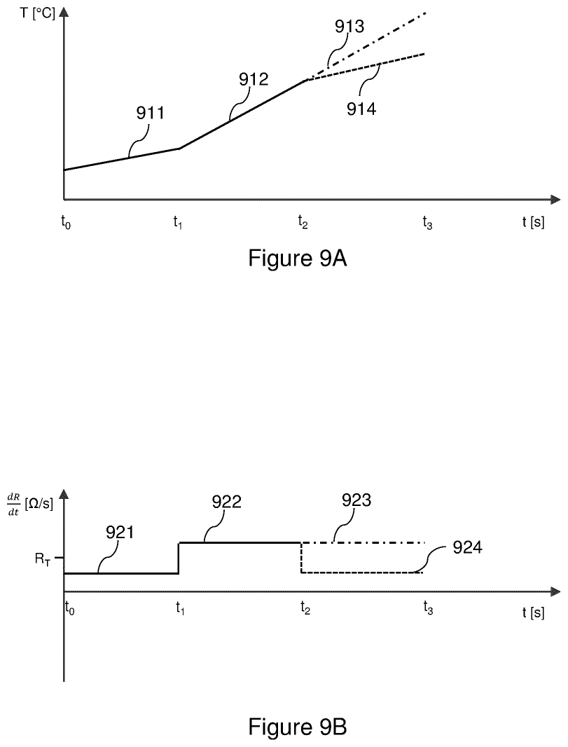

FIG. 9A shows a graph illustrating temperature variations of a susceptor during heating of the susceptor;

FIG. 9B shows a graph illustrating the rate of change of apparent ohmic resistance of the inductor coil associated with the temperature variations illustrated in FIG. 9A;

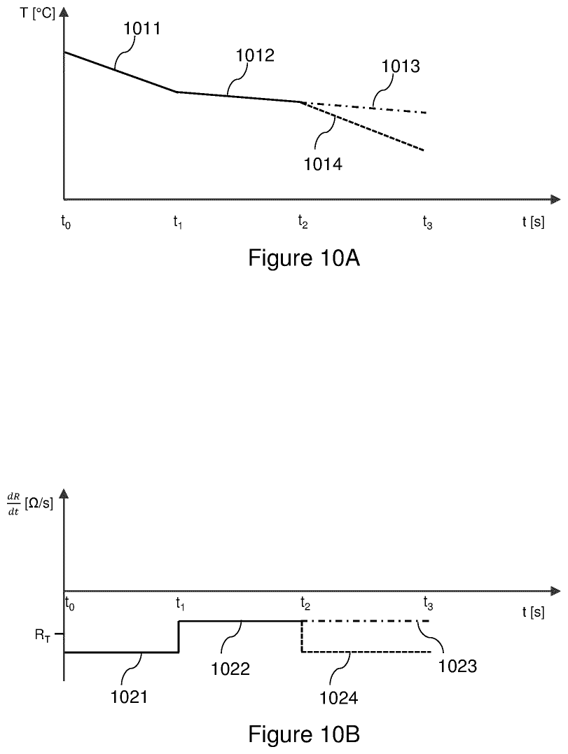

FIG. 10A shows a graph illustrating temperature variations of a susceptor during cooling of the susceptor; and

FIG. 10B shows a graph illustrating the rate of change of apparent ohmic resistance of the inductor coil associated with the temperature variations illustrated in FIG. 10A.

FIG. 1A shows a schematic illustration of an aerosol-generating system according to an example of the present disclosure. The aerosol-generating system comprises a cartridge 10 and an aerosol-generating device 60. The cartridge 10 may be received by the aerosol-generating device 60. FIG. 1B shows a schematic illustration of the aerosol-generating system of FIG. 1A in which the cartridge 10 is received by the aerosol-generating device 60. The aerosol-generating system is portable and has a size comparable to a conventional cigar or cigarette.

The cartridge 10 has a mouth end and a connection end. The connection end is disposed opposite the mouth end. An outer housing 36 defines a mouth end air outlet 38 at the mouth end of the cartridge 10. The cartridge 10 may further comprise a mouthpiece at the mouth end. The connection end is configured for connection of the cartridge 10 to the aerosol-generating device 60, as described in more detail below.

The outer housing 36 is formed from a mouldable plastics material, such as polypropylene. The external width of the outer housing 36 is greater at the mouth end of the cartridge 10 than at the connection end. This forms a shoulder 37 between the mouth end and the connection end. This enables the connection end of the cartridge 10 to be received in a cavity 64 of the aerosol-generating device 60, with the shoulder 37 locating the cartridge 10 in the correct position in the aerosol-generating device 60. This also enables the mouth end of the cartridge 10 to remain outside of the aerosol-generating device 60, with the mouth end conforming to the external shape of the aerosol-generating device 60.

The cartridge 10 further comprises a liquid reservoir 44. The liquid reservoir 44 is for storing a liquid aerosol-forming substrate 42. The liquid reservoir 44 extends from the mouth end of the outer housing 36 to the connection end of the outer housing 36, and comprises an annular space defined by the outer housing 36. The annular space has an internal passage 48 that extends between the mouth end air outlet 38, and the open end of an internal passage 26 of a susceptor holder 14.

The liquid reservoir 44 further comprises two channels 45. The two channels 45 are defined between an inner surface of the outer housing 36 and an outer surface of the susceptor holder 14. The two channels 45 extend from the annular space defined by the outer housing 36 at the mouth end of the cartridge 10 to the connection end of the cartridge 10. The two channels 45 extend on opposite sides of the internal passage 26 of the susceptor holder 14.

The susceptor holder 14 comprises a base 30 that partially closes one end of the internal passage 26. The base 30 comprises air inlets 32 that enable air to be drawn into the internal passage 26 through the partially closed end.

An air passage is formed through the cartridge 10 by the internal passage 26 of the susceptor holder 14, and the internal passage 48 of the liquid reservoir 44. The air passage extends from the air inlets 32 in the base 30 of the susceptor holder 14, through the internal passage 26 of the susceptor holder 14, and through the internal passage 48 of the liquid reservoir 44 to the mouth end air outlet 38. The air passage enables air to be drawn through the cartridge 10 from the connection end to the mouth end.

The cartridge 10 comprises a susceptor assembly 12 mounted in a susceptor holder 14. The susceptor assembly 12 and the susceptor holder 14 are located towards the connection end of the cartridge 10. The susceptor assembly 12 is planar, and thin, having a thickness dimension that is substantially smaller than a length dimension and a width dimension. The susceptor assembly 12 is shaped in the form of a rectangle.

The susceptor assembly 12 comprises a susceptor comprising a first susceptor element 16 and a second susceptor element 18. It should be understood that in other embodiments the susceptor may comprise a single susceptor element.

The susceptor assembly 12 also comprises a wicking element for transporting the liquid aerosol-forming substrate 42 from the liquid reservoir 44 to the susceptor. The wicking element comprises a first wicking layer 20 and a second wicking layer 22. The susceptor assembly 12 further comprises a spacer element, not shown in FIG. 1A.

Each of the first susceptor element 16, the second susceptor element 18, the first wicking layer 20 and the second wicking layer 22 generally form the shape of a rectangle. Each susceptor layer has the same length and width dimensions. The width of the susceptor elements 16, 18 is smaller than the width of the first wicking layer 20 and the second wicking layer 22. Therefore, each of the first wicking layer 20 and the second wicking layer 22 comprise outer, exposed portions of wicking element that protrude through openings in the side wall of the susceptor holder 14 into the two channels 45. The first and second susceptor elements 16, 18 are substantially identical, and comprise a sintered mesh formed from ferritic stainless steel filaments and austenitic stainless steel filaments. The first wicking layer 20 and the second wicking layer 22 comprise a porous body of cotton filaments. The wicking element is configured to supply liquid aerosol-forming substrate 42 from the outer, exposed surfaces of the first wicking layer 20 and the second wicking layer 22 to the first and second susceptor elements 16, 18.

The first and second susceptor elements 16, 18 are configured to be heated by penetration with an alternating magnetic field for vaporising the liquid aerosol-forming substrate 42. The wicking element contacts the susceptor holder 14, such that the susceptor holder 14 supports the susceptor assembly 12 in position in the cartridge 10.

The susceptor assembly 12 is partially arranged inside the internal passage 26 of the tubular susceptor holder 14, and extends in a plane parallel to a central longitudinal axis of the susceptor holder 14. The first and second susceptor elements 16, 18 are arranged entirely within the internal passage 26 of the susceptor holder 14.

The aerosol-generating device 60 comprises a generally cylindrical housing 62 having a connection end and a distal end opposite the connection end. A cavity 64 for receiving the connection end of the cartridge 10 is located at the connection end of the device 60. An air inlet 65 is provided through the outer housing 62 at the base of the cavity 64 to enable ambient air to be drawn into the cavity 64 at the base.

The aerosol-generating device 60 comprises an inductive heating arrangement arranged within the device outer housing 62. The inductive heating arrangement includes an inductor coil 90, control circuitry 70 and a power supply 72. The power supply 72 comprises a rechargeable nickel cadmium battery, that is rechargeable via an electrical connector (not shown) at the distal end of the device 60. The control circuitry 70 is connected to the power supply 72, and to the inductor coil 90, such that the control circuitry 70 controls the supply of electricity to the inductor coil 90. The control circuitry 70 is configured to supply an alternating current to the inductor coil 90.

The inductor coil 90 is positioned around the susceptor assembly 12 when the cartridge 10 is received in the cavity 64, as shown in FIG. 1B. The inductor coil 90 has a size and a shape matching the size and shape of heating regions of the susceptor elements. The inductor coil 90 is made with a copper wire having a round circular section, and is arranged on a coil former element (not shown). The inductor coil 90 is a helical coil, and has a circular cross section when viewed parallel to the longitudinal axis of the aerosol-generating device 60.

The inductor coil 90 is configured such that when the alternating current is supplied to the inductor coil, the inductor coil generates an alternating magnetic field in the region of the susceptor assembly 12 when the cartridge 10 is received in the cavity 64.

The inductive heating arrangement further includes a flux concentrator element 91. The flux concentrator element 91 has a greater radius than the inductor coil 90, and so partially surrounds the inductor coil 90. The flux concentrator element 91 is configured to reduce the stray power losses from the generated magnetic field.

FIG. 1B shows the aerosol-generating system of FIG. 1A, wherein the cartridge 10 is received within the aerosol-generating device 60. In operation, when a user puffs on the mouth end air outlet 38 of the cartridge 10, ambient air is drawn into the base of the cavity 64 through system air inlet 65, and into the cartridge 10 through the air inlets 32 in the base 30 of the cartridge 10. The ambient air flows through the cartridge 10 from the base 30 to the mouth end air outlet 38, through the air passage, and over the susceptor assembly 12 and in particular over and across the first susceptor element 16 and the second susceptor element 18.

The control circuitry 70 controls the supply of electricity from the power supply 72 to the inductor coil 90 when the system is activated. The control circuitry 70 includes an airflow sensor 63. The airflow sensor 63 is in fluid communication with the passage of ambient air which is drawn through the system by the user. The control circuitry 70 supplies electricity to the inductor coil 90 when user puffs on the cartridge 10 are detected by the airflow sensor 63.

When the system is activated, an alternating current is established in the inductor coil 90, which generates an alternating magnetic field in the cavity 64 that penetrate the susceptor assembly 12, causing the susceptor, including the first susceptor element 16 and the second susceptor element 18, to heat. Liquid aerosol-forming substrate 42 in the two channels 45 is drawn into the susceptor assembly 12 through the wicking element to the susceptor. In particular, liquid aerosol-forming substrate 32 is drawn through the first wicking layer 20 and the second wicking layer 22 to the first susceptor element 16 and the second susceptor element 18, respectively. Liquid aerosol-forming substrate 42 may also be transferred between the first wicking layer 20 and the second wicking layer 22, through the spacer element. The liquid aerosol-forming substrate 42 at the susceptor is heated, and volatile compounds from the heated liquid aerosol-forming substrate are released into the air passage of the cartridge 10, which cool to form an aerosol. The aerosol is entrained in the air being drawn through the air passage of the cartridge 10, and is drawn out of the cartridge 10 at the mouth end air outlet 38 for inhalation by the user.

FIG. 2A shows a schematic illustration of the cartridge 10 separately from the aerosol-generating device. FIG. 2B shows a schematic illustration of the cartridge of FIG. 2A rotated by 90 degrees about a central longitudinal axis of the cartridge.

FIG. 2B illustrates the layered structure of the susceptor assembly 12, and depicts the spacer element 24 positioned between and in contact with the first wicking layer 20 and the second wicking layer 22. The spacer element 24 is fluid permeable and is configured to allow the liquid aerosol-forming substrate 42 to move between the first wicking layer 20 and the second wicking layer 22. The spacer element 24 generally forms the shape of a rectangle, and has the same length and width dimensions as the first wicking layer 20 and the second wicking layer 22. The spacer element 24 comprises a porous body of cotton.

FIG. 3 shows a block diagram of electronic components of the aerosol-generating system. The aerosol-generating device 60 comprises the DC power supply 72 (the battery), a microcontroller 301, a DC/AC converter or inverter 302, a matching network 303 for adaptation to the load, and the inductor coil 90. The cartridge 10 comprises the susceptor which comprises the first susceptor element 16 and second susceptor element 18. The microcontroller 301, the DC/AC converter or inverter 302 and matching network 303 are all part of the control circuitry 70. The DC supply voltage V_{DC} and the current I_{DC} drawn from the DC power supply 72 are provided by feed-back channels to the microcontroller 301. This allows the microcontroller 301 to determine an apparent ohmic resistance (or apparent conductance) of the inductor coil based on the DC supply voltage V_{DC} and the current I_{DC} drawn. This may also allow the microcontroller 301 to control the further supply of AC power P_{AC} to the inductor coil 90.

It will be appreciated that the matching network 303 may be provided for optimum adaptation to the load, but the matching network 303 is not essential. The matching network 303 may improve power transfer efficiency between the DC/AC converter 302 and the inductor coil 90.

During operation of the aerosol-generating system, the inductor coil 90 generates a high frequency alternating magnetic field that induces eddy currents in the susceptor that cause the susceptor to heat up. As the susceptor is heated, the apparent ohmic resistance of the inductor coil increases as the temperature of the susceptor increases. This increase in the apparent ohmic resistance of the inductor coil is detected by the control circuitry 70 through measurements of the current drawn I_{DC} from the DC power supply 72 which, at constant voltage, decreases as the temperature and apparent ohmic resistance of the inductor coil increases. Thus, a rate of change of temperature of the susceptor can be determined based on the rate of change of apparent ohmic resistance of the inductor coil.

FIG. 4A shows some more components of the control circuitry 70, more particularly of the DC/AC converter 302. As can be seen from FIG. 4A, the DC/AC converter 302 comprises a Class-E power amplifier comprising a transistor switch 3020 comprising a Field Effect Transistor (FET) 3021, for example a Metal-Oxide-Semiconductor Field Effect Transistor (MOSFET), a transistor switch supply circuit indicated by the arrow 3022 for supplying the switching signal (gate-source voltage) to the FET 3021, and an LC load network 3023 comprising a shunt capacitor C1 and a series connection of a capacitor C2 and inductor L2 which corresponds to inductor coil 90. In addition, the DC power supply 72 comprising a choke L1 is shown for supplying a DC supply voltage V_{DC}, with a current I_{DC} being drawn from the DC power supply 72 during operation. As shown in FIG. 4B, the ohmic resistance R represents the total ohmic load, which is the sum of the ohmic resistance R_{coil} of the inductor L2 and the ohmic resistance R_{load} of the susceptor. The total ohmic load is the apparent ohmic resistance of the inductor coil 90. The ohmic resistance R_{coil} of the inductor L2 does not vary greatly during operation of the aerosol-generating system. Thus, a change in the total ohmic load (or apparent ohmic resistance) can be attributed to the change in ohmic resistance R_{load} of the susceptor.

FIGS. 5, 6 and 7 show an illustration of scenarios in which the supply of liquid aerosol-forming substrate 42 from the liquid reservoir 44 to susceptor may be insufficient to produce a satisfactory aerosol.

FIG. 5 shows a schematic illustration of a cross-section of the cartridge 10 of FIG. 1A in which the liquid reservoir 44 is empty. In this scenario, there is no liquid aerosol-forming substrate 42 in contact with the first wicking layer 20 or the second wicking layer 22. Therefore, no liquid aerosol-forming substrate 42 is supplied to the first susceptor element 16 or the second susceptor element 18.

FIG. 6 shows a schematic illustration of a cross-section of the cartridge 10 of FIG. 1A in which the liquid reservoir 44 is nearly empty. In this scenario only part of the first wicking layer 20 and the second wicking layer 22 are in contact with the remaining liquid aerosol-forming substrate 42. This may lead to an insufficient supply of liquid aerosol-forming substrate 42 to the first susceptor element 16 and the second susceptor element 18.

FIG. 7 shows a schematic illustration of a cross-section of the cartridge 10 of FIG. 1A in which there is no liquid aerosol-forming substrate 42 in contact with the first wicking layer 20 or the second wicking layer 22 due to how the cartridge 10 is orientated. This may happen when the liquid reservoir 44 has been partially depleted and a user holds the aerosol-generating system in certain orientations, for example upside down. In this scenario, there is no liquid aerosol-forming substrate 42 supplied to the first susceptor element 16 or the second susceptor element 18. However, the interruption of the supply of liquid aerosol-forming substrate 42 to the first susceptor element 16 and the second susceptor element 18 may only be temporary. This is because after a short period of time a user may reorientate the aerosol-generating system such that liquid aerosol-forming substrate 42 is in contact with the first wicking layer 20 and the second wicking layer 22.

It will be appreciated that there are other scenarios in which the supply of liquid aerosol-forming substrate 42 to the first susceptor element 16 and the second susceptor element 18 may be temporarily interrupted or be otherwise insufficient. For example, when a user puffs too hard on the mouth end air outlet 38, the liquid aerosol-forming substrate 42 may be aerosolized at a rate greater than a rate at which the liquid aerosol-forming substrate 42 is supplied to the first susceptor element 16 and the second susceptor element 18.

It is possible to detect whether the susceptor is supplied with, or is not supplied with, liquid aerosol-forming substrate 42 by monitoring the temperature of the susceptor, in particular the rate of temperature change of the susceptor. This allows appropriate action to be taken when it is detected that the susceptor is not supplied with liquid aerosol-forming substrate. The rate of temperature change of the susceptor can be monitored indirectly by monitoring the rate of change of apparent ohmic resistance (or apparent conductance) of the inductor coil 90.

FIG. 8A shows a graph illustrating an example of temperature variations of a susceptor when the susceptor is supplied with liquid aerosol-forming substrate 42 and when the susceptor is not supplied with liquid aerosol-forming substrate 42. FIG. 8B shows a graph illustrating the rate of change of apparent ohmic resistance of the inductor coil 90 associated with the temperature variations illustrated in FIG. 8A.

FIG. 8A depicts a first line 801 representing the temperature variation of the susceptor when the susceptor is supplied with liquid aerosol-forming substrate 42. At time t₀ a user begins to puff on the aerosol-generating system. Thus, the control circuitry 70 begins to supply electricity to the inductor coil 90 to heat up the susceptor from a first temperature at time t₀ to an operating temperature T_{O} at time t₂. From time t₂ to time t₃ the control circuitry 70 controls the supply of electricity to the inductor coil 90 in order to maintain the temperature of the susceptor at the operating temperature T_{O}. The temperature between time t₂ to time t₃ is depicted as being constant in FIG. 8A, however, this is for illustration purposes. In reality, there will be minor variations in temperature of the susceptor as the susceptor cools and is subsequently reheated to maintain the operating temperature T_{O}. The user stops puffing on the aerosol-generating system at time t₃, and so the control circuitry 70 stops supplying electricity to the inductor coil 90 and the susceptor subsequently begins to cool from time t₃ to time t₄.

FIG. 8A depicts a second line 802 representing the temperature variation of the susceptor when the susceptor is not supplied with liquid aerosol-forming substrate 42. At time t₀ a user begins to puff on the aerosol-generating system. Thus, the control circuitry 70 begins to supply electricity to the inductor coil 90 to heat up the susceptor. It is seen that the susceptor heats up more quickly when the susceptor is not supplied with liquid aerosol-forming substrate compared to when the susceptor is supplied with liquid aerosol-forming substrate. This shown by the temperature of the susceptor increasing from the first temperature at time t₀ to the operating temperature T_{O} at time t₁ where t₁ is less than t₂. This is because heat from the susceptor is not able to be transferred to the liquid aerosol-forming substrate 42. The user stops puffing on the aerosol-generating system at time t₃, and so the control circuitry 70 stops supplying electricity to the inductor coil 90 and the susceptor subsequently begins to cool from time t₃ to time t₄. It is seen that the susceptor cools more slowly when the susceptor is not supplied with liquid aerosol-forming substrate 42 compared to when the susceptor is supplied with liquid aerosol-forming substrate 42.

FIG. 8B depicts a first line 803 representing the rate of change of apparent ohmic resistance of the inductor coil 90 during the temperature variation depicted by the first line 801 in FIG. 8A. FIG. 8B also depicts a second line 804 representing the rate of change of apparent ohmic resistance of the inductor coil 90 during the temperature variation depicted by the second line 802 in FIG. 8A. The relationship between the apparent ohmic resistance of the inductor coil and the temperature of the susceptor is depicted as being linear. However, it will be appreciated that other monotonic relationships between the apparent resistance of the inductor coil and the temperature of the susceptor are possible.

The first line 803 in FIG. 8B shows that the rate of change of apparent resistance of the inductor coil remains relatively constant during heating of the susceptor from the first temperature to the operating temperature T_{O}. During this period the rate of change of apparent ohmic resistance is positive. That said, the rate of change of the apparent ohmic resistance decreases as the temperature of the susceptor approaches the operating temperature T_{O}. From time t₂ to time t₃ the rate of change of apparent resistance is around zero. However, as previously mentioned, there will be cooling and heating of the susceptor during this time period. Therefore, the rate of change of apparent ohmic resistance of the inductor coil will fluctuate between being positive, being zero, and being negative. From time t₃ to t₄, the rate of change of apparent ohmic resistance of the inductor coil is negative due to the cooling of the susceptor.

The second line 804 in FIG. 8B shows that the magnitude of the rate of change of apparent ohmic resistance of the inductor coil during periods when the susceptor is being heated is greater when liquid aerosol-forming substrate is not supplied to the susceptor compared to when liquid aerosol-forming substrate is supplied to the susceptor. On the other hand, the second line 804 in FIG. 8B shows that the magnitude of the rate of change of apparent ohmic resistance of the inductor coil during periods when the susceptor is cooling is less when liquid aerosol-forming substrate is not supplied to the susceptor compared to when liquid aerosol-forming substrate is supplied to the susceptor. Thus, it is possible to determine whether liquid aerosol-forming substrate is supplied to the susceptor by comparing the rate of change of apparent ohmic resistance of the inductor coil to a dry susceptor threshold. The dry susceptor threshold may be a rate of change of apparent ohmic resistance of the inductor coil that is indicative of liquid aerosol-forming substrate not being supplied to the susceptor.

The DC supply voltage supplied by the power supply 72 is kept constant. Thus, the apparent ohmic resistance of inductor coil can be determined by measuring the electrical current that is drawn by the inductor coil 90. The apparent ohmic resistance of the inductor coil can then be determined using Ohm's Law. The rate of change of apparent ohmic resistance can be determined by taking a first measurement of apparent ohmic resistance at a first time and a second measurement of apparent ohmic resistance at a second time. It is preferable that the time interval between the first measurement and the second measurement is small.

During periods when the susceptor is being heated, electricity is already being supplied to the inductor coil 90. Thus, the current being drawn during heating can be used to determine the apparent ohmic resistance of the inductor coil. However, at other times it may be necessary to supply the inductor coil with electricity specifically to allow the determination of the apparent ohmic resistance of the inductor coil. In this case, electricity should be supplied to the inductor coil for only a short period in order to avoid any substantial heating of the susceptor.

FIG. 9A shows a graph illustrating temperature variations of the susceptor during a heating period of the susceptor. FIG. 9B shows a graph illustrating the rate of change of apparent ohmic resistance of the inductor coil associated with the temperature variations illustrated in FIG. 9A. There are two scenarios illustrated in FIGS. 9A and 9B. In the first scenario, the liquid reservoir 44 becomes depleted of liquid aerosol-forming substrate 42, as depicted in FIG. 5, and consequently no liquid aerosol-forming substrate 42 is supplied to susceptor. In the second scenario, the liquid reservoir 44 is not depleted of liquid aerosol-forming substrate 42, however, the supply of liquid aerosol-forming substrate 42 to the susceptor becomes temporarily interrupted, as depicted in FIG. 7.

FIGS. 9A and 9B show a first phase of heating of the susceptor from t₀ to t₁, a second phase of heating of the susceptor from t₁ to t₂, and a third phase of heating of the susceptor from t₂ to t₃.

In both scenarios, the rate of increase of temperature of the susceptor, depicted by line 911, during the first phase of heating is indicative of a susceptor that is supplied with liquid aerosol-forming substrate 42. This is shown by the rate of change of apparent ohmic resistance of the inductor coil, depicted by line 921, being less than the dry susceptor threshold R_{T}. Thus, by comparing the rate of change of apparent ohmic resistance of the inductor coil with the dry susceptor threshold R_{T}, the control circuitry 70 determines that the susceptor is supplied with liquid aerosol-forming substrate during the first phase of heating.

In both scenarios, the rate of increase of temperature of the susceptor, depicted by line 912, during the second phase of heating is indicative of a susceptor that is not supplied with liquid aerosol-forming substrate 42. This is shown by the rate of change of apparent ohmic resistance of the inductor coil, depicted by line 922, being greater than the dry susceptor threshold R_{T}. Thus, by comparing the rate of change of apparent resistance of the inductor coil with the dry susceptor threshold R_{T}, the control circuitry 70 determines that the susceptor is not supplied with liquid aerosol-forming substrate during the second phase of heating.

In the first scenario, the rate of increase of temperature of the susceptor, depicted by line 913, during the third heating phase is indicative of a susceptor that is not supplied with liquid aerosol-forming substrate 42. This is shown by the rate of change of apparent ohmic resistance of the inductor coil, depicted by line 923, remaining greater than the dry susceptor threshold R_{T}. However, in the second scenario, during the third heating phase, the rate that is supplied with liquid aerosol-forming substrate 42. This is shown by the rate of change of apparent ohmic resistance of the inductor coil, depicted by line 924, being less than the dry susceptor threshold R_{T}.

The control circuitry 70 is configured to distinguish between these two scenarios.

In the first scenario, the control circuitry 70 is configured to determine that the liquid reservoir 44 is depleted when the susceptor is not supplied with liquid aerosol-forming substrate 42 for a length of time equal to, or greater than, a time threshold. In this instance, the time threshold is equal to the length of time from t₁ to t₃ which is 100 milliseconds. The control circuitry 70 may then be configured to stop the supply of electricity to the inductor coil 90 until the cartridge 10 is replaced or refilled. Additionally, or alternatively, the control circuitry 70 may be configured to alert the user that the cartridge 10 needs to be replaced or refilled.

In the second scenario, the control circuitry 70 is configured to detect the temporary interruption when the susceptor is not supplied with liquid aerosol-forming substrate 42 for a length of time less than the time threshold. The control circuitry 70 may consider this to be an abnormal condition. The control circuitry 70 may take no action with regard to the temporary interruption in the supply of liquid aerosol-forming substrate 42 to the susceptor. Alternatively, the control circuitry 70 may be configured to alert the user to the temporary interruption in the supply of liquid aerosol-forming substrate to the susceptor.

FIG. 10A shows a graph illustrating temperature variations of the susceptor during a cooling period of the susceptor. FIG. 10B shows a graph illustrating the rate of change of apparent ohmic resistance of the inductor coil associated with the temperature variations illustrated in FIG. 10A. Similarly to FIGS. 9A and 9B, there are two scenarios illustrated in FIGS. 10A and 10B. In the first scenario, the liquid reservoir 44 becomes depleted of liquid aerosol-forming substrate 42, as depicted in FIG. 5, and consequently no liquid aerosol-forming substrate is supplied to susceptor. In the second scenario, the liquid reservoir 44 is not depleted of liquid aerosol-forming substrate 42, however, the supply of liquid aerosol-forming substrate 42 to the susceptor becomes temporarily interrupted, as depicted in FIG. 7.

FIGS. 10A and 10B show a first phase of cooling of the susceptor from t₀ to t₁, a second phase of cooling of the susceptor from t₁ to t₂, and a third phase of cooling of the susceptor from t₂ to t₃.

In both scenarios, the rate of decrease of temperature of the susceptor, depicted by line 1011, during the first phase of cooling is indicative of a susceptor that is supplied with liquid aerosol-forming substrate 42. This is shown by the rate of change of apparent ohmic resistance of the inductor coil, depicted by line 1021, being less than the dry susceptor threshold R_{T}. Thus, by comparing the rate of change of apparent ohmic resistance of the inductor coil with the dry susceptor threshold R_{T}, the control circuitry 70 determines that the susceptor is supplied with liquid aerosol-forming substrate 42 during the first phase of cooling.

In both scenarios, the rate of decrease of temperature of the susceptor, depicted by line 1012, during the second phase of cooling is indicative of a susceptor that is not supplied with liquid aerosol-forming substrate 42. This is shown by the rate of change of apparent ohmic resistance of the inductor coil, depicted by line 1022, being greater than the dry susceptor threshold R_{T}. Thus, by comparing the rate of change of apparent resistance of the inductor coil with the dry susceptor threshold R_{T}, the control circuitry 70 determines that the susceptor is not supplied with liquid aerosol-forming substrate during the second period of cooling.

In the first scenario, the rate of decrease of temperature of the susceptor, depicted by line 1013, is indicative of a susceptor that is not supplied with liquid aerosol-forming substrate 42. This is shown by the rate of change of apparent ohmic resistance of the inductor coil, depicted by line 1023, remaining greater than the dry susceptor threshold R_{T}. However, in the second scenario, the rate of decrease of temperature of the susceptor, depicted by line 1014, is indicative of a susceptor that is supplied with liquid aerosol-forming substrate 42. This is shown by the rate of change of apparent ohmic resistance of the inductor coil, depicted by line 1024, being less than the dry susceptor threshold R_{T}.

As described in relation to FIGS. 9A and 9B, the control circuitry 70 is configured to distinguish between these two scenarios by using a time threshold.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating system, comprising:
a liquid reservoir configured to store a liquid aerosol-forming substrate;
a susceptor configured to receive a supply of liquid aerosol-forming substrate from the liquid reservoir and to heat the liquid aerosol-forming substrate to form an aerosol;
an inductor coil configured to generate an alternating magnetic field for heating the susceptor;
a power supply configured to supply electricity to the inductor coil; and
control circuitry configured to
determine a parameter indicative of a rate of temperature change of the susceptor, based on the electricity supplied to the inductor coil, and
determine whether the susceptor is supplied with the liquid aerosol-forming substrate, based on a comparison between a dry susceptor threshold and the parameter indicative of the rate of temperature change of the susceptor.

17. The aerosol-generating system according to claim 16, wherein the parameter indicative of the rate of temperature change of the susceptor is a rate of change of apparent ohmic resistance of the inductor coil.

18. The aerosol-generating system according to claim 16, wherein the parameter indicative of the rate of temperature change of the susceptor is based on a first measurement of the electricity supplied to the inductor coil and a second measurement of the electricity supplied to the inductor coil.

19. The aerosol-generating system according to claim 18,
wherein the first measurement and the second measurement are separated by an interval of time, and
wherein the interval of time is less than 500 milliseconds.

20. The aerosol-generating system according to claim 16, wherein the control circuitry is further configured to determine the parameter indicative of the rate of temperature change of the susceptor, based on the electricity supplied to the inductor coil during a cooling period of the susceptor.

21. The aerosol-generating system according to claim 16, wherein the control circuitry is further configured to determine that the susceptor is not supplied with liquid aerosol-forming substrate when the parameter indicative of the rate of temperature change of the susceptor is greater than the dry susceptor threshold.

22. The aerosol-generating system according to claim 16, wherein the control circuitry is further configured to determine whether the liquid reservoir is depleted based on whether the susceptor is supplied with liquid aerosol-forming substrate.

23. The aerosol-generating system according to claim 16, wherein the control circuitry is further configured to determine that the liquid reservoir is depleted when the susceptor is not supplied with liquid aerosol-forming substrate for a length of time equal to, or greater than, a time threshold.

24. The aerosol-generating system according to claim 16, wherein the control circuitry is further configured to detect an abnormal condition when the susceptor is not supplied with liquid aerosol-forming substrate for a length of time less than a time threshold.

25. The aerosol-generating system according to claim 16, wherein the control circuitry is further configured to:
operate the aerosol-generating system in a first mode and a second mode, the first mode being different from the second mode,
operate the aerosol-generating system in the first mode when the susceptor is supplied with liquid aerosol-forming substrate, and
operate the aerosol-generating system in the second mode when the susceptor is not supplied with liquid aerosol-forming substrate.

26. The aerosol-generating system according to claim 16, wherein the control circuitry is further configured to determine the dry susceptor threshold based on an initial supply of electricity to the inductor coil.

27. The aerosol-generating system according to claim 26, wherein the susceptor is not supplied with liquid aerosol-forming substrate during the initial supply of electricity to the inductor coil.

28. The aerosol-generating system according to claim 27,
wherein the control circuitry is further configured to determine a parameter indicative of an initial rate of temperature change of the susceptor, based on the initial supply of electricity to the inductor coil, and
wherein the dry susceptor threshold is the parameter indicative of the initial rate of temperature change of the susceptor.

29. The aerosol-generating system according to claim 16, wherein the susceptor is in the form of a mesh.

30. A method of controlling an aerosol-generating system comprising a liquid reservoir configured to store a liquid aerosol-forming substrate, a susceptor configured to receive a supply of the liquid aerosol-forming substrate and an inductor coil configured to generate an alternating magnetic field for heating the susceptor, the method comprising:
supplying electricity to the inductor coil;
determining a parameter indicative of a rate of temperature change of the susceptor, based on the electricity supplied to the inductor coil; and
determining whether the susceptor is supplied with the liquid aerosol-forming substrate, based on a comparison between a dry susceptor threshold and the parameter indicative of the rate of temperature change of the susceptor.
